(19) United States
(12) Patent Application Publication
(10) Pub. No.: US 2011/0314044 A1
(43) Pub. Date: Dec. 22, 2011

(54) FLEXIBLE CONTENT ORGANIZATION AND RETRIEVAL

(75) Inventors: Susan T. Dumais, Kirkland, WA (US); Shane Williams, Seattle, WA (US)

(73) Assignee: Microsoft Corporation, Redmond, WA (US)

(21) Appl. No.: 12/818,451

(22) Filed: Jun. 18, 2010

(51) Int. Cl. G06F 17/30; G06F 3/048

(52) U.S. Cl. 707/769; 715/810; 715/769; 707/802; 707/E17.014; 707/E17.044

(57) ABSTRACT

Among other things, one or more techniques and systems are disclosed for saving and retrieving browser-based content or portions thereof for browser-based interactions. Metadata is generated for a selection of a portion or an entire browser page, when a user selects content for the page. The selected content, comprising at least a portion of the browser page, is stored in a database in a remote data store, where the database is indexed by the associated metadata. The selection is presented in a multi-level representation in a user interface (UI) by using the associated metadata to organize the selection(s) in the UI.

### BACKGROUND

Browsers are programs that run on computing devices that can be used for retrieving, viewing, and navigating through resources, such as using the Internet to access the world wide web. As an example, a browser can access a resource using a Uniform Resource Identifier (URI) that identifies the resource, such as a website or webpage, images, video, or other online content. Browsers can also utilize hyperlinks, which are links to other resources that provide quick and easy navigation. Browsers are often used access the Internet, but they can also be used to access resources on intranets, private web servers, and/or private file systems, for example. There are many, many resources available online, however, and conventional technologies are limited in their ability to assist users with tracking or revisiting encountered content.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Many browser-based tasks can extend over time (e.g., planning a trip or understanding an evolving medical condition can involve many search and browsing sessions over weeks). While web browsers and search engines can help users discover new information, they provide limited functionality to support saving and revisiting or “re-finding” information encountered along the way. Browsers provide some capabilities to get back to pages that have been annotated, such as “favorites” or saved in history, but these types of stored data are local to the machine or browser and offer limited types of access mechanisms.

Some systems support cloud-based (e.g., using remote server farms and datacenters) storage of application-specific data (e.g., a record of search queries and clicked URLs, a record of movies rented and rated); however, these merely cover interactions with a specific search service (e.g., Web service) or with a specific Web service (e.g., some saved pages may have nothing to do with search). Further, these systems typically operate at a level of webpages and do not provide a means for saving specific regions of interest (e.g., an image or table or paragraph from a large document, such as a web page or other more global unit of content).

Accordingly, among other things, one or more techniques and systems are provided that address at least some of the shortcomings described above by providing a user friendly, simple way of saving and flexibly finding (again) personally interesting content (e.g., personal to the user). In one embodiment, a browser add-in may be provided that supports identifying items of interest (e.g., webpages, elements of browser-based pages, etc.), generating metadata associated with the items, saving the items and metadata in the cloud, for example, indexing the content and metadata, and providing for flexible search and views of the information.

In one embodiment for saving and retrieving browser-based content or portions thereof for browser-based interactions, when a user selects at least a portion of a browser page (e.g., part of a webpage or the entire webpage), metadata that is associated with the selection is generated, such as a time, task, or search-related information. The selection made by the user is stored in a remote data store, in a database (and/or other suitable mechanism(s)) for the selection that is indexed by the associated metadata, such as metadata that may identify the full content of the selection and/or metadata that identifies concepts associated with selection, such as time, task or search-related information. It will be appreciated that the term “database” is merely used to differentiate from the remote data store and is not provided as a limitation to merely a traditional database. That is, the selections may not merely be stored in a traditional database (e.g., SQL format database), but can be stored in any appropriate manner(s) that provide for storing and retrieving the data (selections) in the remote data store. Similarly, it will also be appreciated that although metadata generally or more conventionally refers to data about data, as opposed to the actual data itself, as used herein metadata can comprise actual data as well. Accordingly, as used herein, metadata can not only comprise aspects such as time, task and/or other information about the data, but can also comprise the data itself such as the full (e.g., text) content in the selection or the full page. Thus, while the full text content in the selection or the full page may not conventionally be regarded as metadata, these items may fall within the meaning of metadata as that term is used herein. A multi-level representation of the selection can be presented in a user interface (UI) by using the associated metadata to organize the selection(s) in the UI.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram of an exemplary method for saving and retrieving browser-based content or portions thereof for browser-based interactions.

FIG. 2 illustrates an example environment where one or more techniques and/or systems, described herein, may be implemented.

FIG. 3 is a flow diagram illustrating an exemplary embodiment where one or more of portions of a method for saving and retrieving browser-based content or portions thereof for browser-based interactions may be implemented.

FIG. 4 is a component diagram of an exemplary system for saving and retrieving browser-based content or portions thereof for browser-based interactions.

FIG. 5 is a component diagram illustrating one embodiment where one or more systems described herein may be implemented.

FIG. 6 is an illustration of an exemplary computer-readable medium comprising processor-executable instructions configured to embody one or more of the provisions set forth herein.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

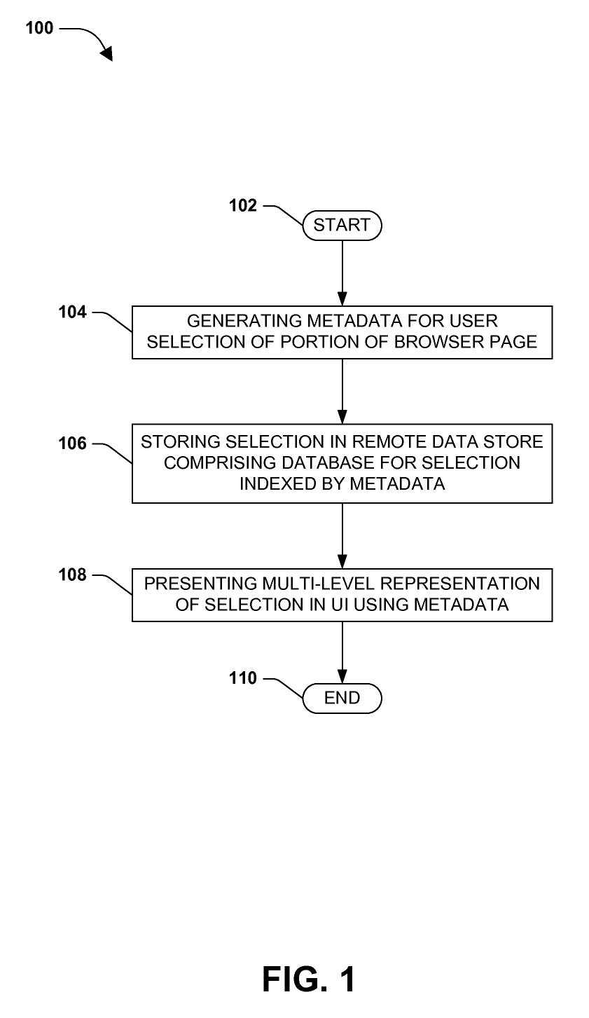

FIG. 1 is a flow diagram of an exemplary method 100 for saving and retrieving browser-based content or portions thereof for browser-based interactions. The exemplary method 100 begins at 102, when a user selects at least a portion of a browser page (e.g., webpage running in a browser environment), metadata that is associated with the selection is generated, at 104. Metadata comprises data about the selection, which can be linked to the selection for later retrieval, such as when searching for the selection using a particular aspect (e.g., described by the metadata).

In one embodiment, the selection may comprise a webpage to which the user has navigated while using the browser. In this embodiment, the entire webpage is selected by the user, for example, and metadata that describes or is associated with the webpage is generated. In another embodiment the user may select merely a portion of the webpage, such as a text box, image, or a combination of items/content on a webpage. Further, in another embodiment, the user may be running the browser to view and interact with non-web related pages, and may select pages, or portions thereof, for which metadata can be generated. In one example, the selection can be via a drag and drop action where the user “grabs” some content and places it into an associated user interface (UI).

At 106, the selection (e.g., selected by the user) is stored in a remote data store that comprises a database (e.g., a selection data store) in which to store the selection, where the database is indexed by the associated metadata (e.g., metadata identifying time, task, search, and/or full content information about the selection). In one embodiment, the remote data store comprises a cloud-based data storage environment, that may be distributed over a plurality of servers (e.g., in data centers and/or server farms), for example. In this embodiment, the selection and metadata can be loaded to the database using an Internet connection to the cloud-based storage. Further, the selection information can be stored in the database in the remote data store, and the database can utilize the metadata to index the stored selections. For example, an index for the database can identify the selection stored in the database in a plurality of ways, such as by a plurality of different types of metadata (e.g., time related, location related, task related, etc.).

At 108, the selection is presented in a multi-level representation in a user interface (UI), using the associated metadata. Having presented the multi-level representation of the selection in the UI, the exemplary method 100 ends at 110.

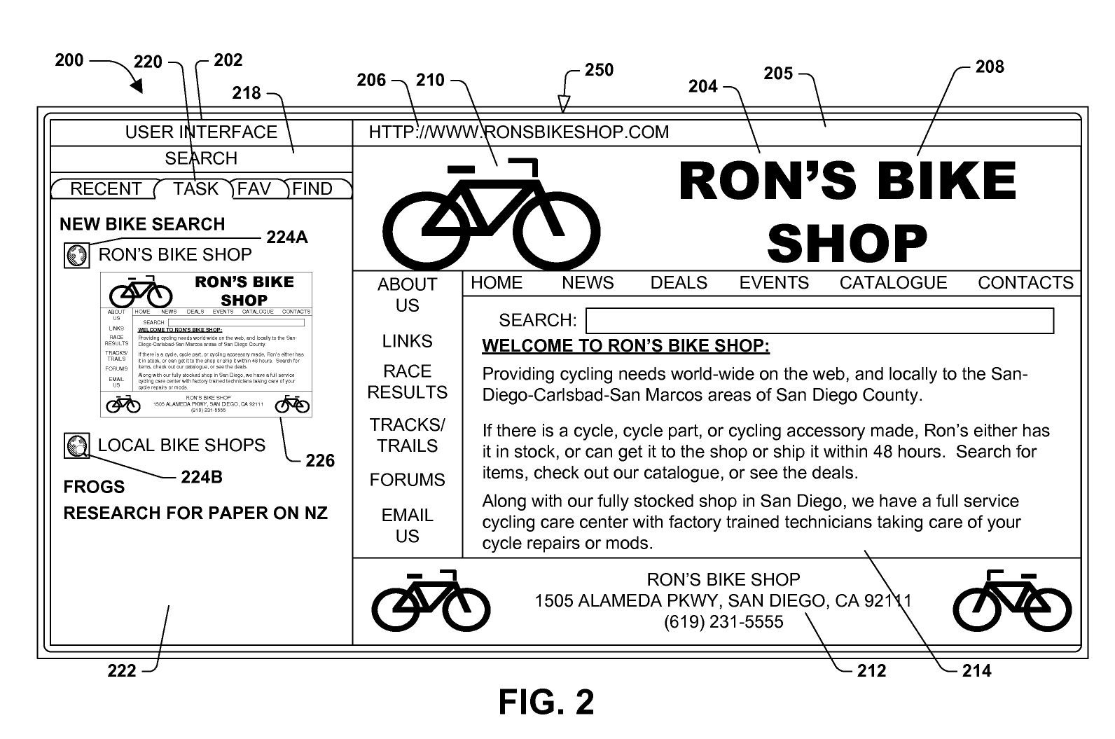

FIG. 2 illustrates an example environment 200 where one or more techniques and/or systems, described herein, may be implemented. In this example environment 200, a browser environment 250 comprises a webpage 205 (presently displaying a page/content related to Ron's Bike Shop homepage 204 as indicated by a particular URL 206) and a UI 202. In the UI 202, a field 222 associated with a corresponding tab 220 (that has been selected) can present one or more selections, such as 224A and 224B, in a multi-level representation. It will be appreciated that, depending upon the tab selected, other selections, or portions thereof, may be presented in different manners and/or corresponding fields.

By way of example, the selection(s) can be represented using automatically generated metadata labels that may (or may not) be correlated to one or more tabs 220 (e.g., time-based, such as the recent tab; task-based; and/or favorites tagged by the user, such as the fav tab), where the tabs represent different manners or levels of selection and presentation. Further, as an example, the respective labels or tags presented when a tab is selected, such as “New Bike Search,” “Frogs,” and “research for paper on NZ,” may represent a multi-level presentation. For example, when the user selects “New Bike Search” (e.g., by clicking on it) it can expand to comprise individual selections, such as Ron's Bike Shop 224A, and Local Bike Shops 224B, as illustrated in FIG. 2, where the selections of Ron's Bike Shop 224A and Local Bike Shops 224B would not, however, be presented if a different label, such as “Frogs”, for example, was selected instead, in which case a selection comprising a picture of a frog, for example, may be presented in the field 222. It will be appreciated the FIG. 2 will be discussed further, at times with in conjunction with discussions of one or more other figures.

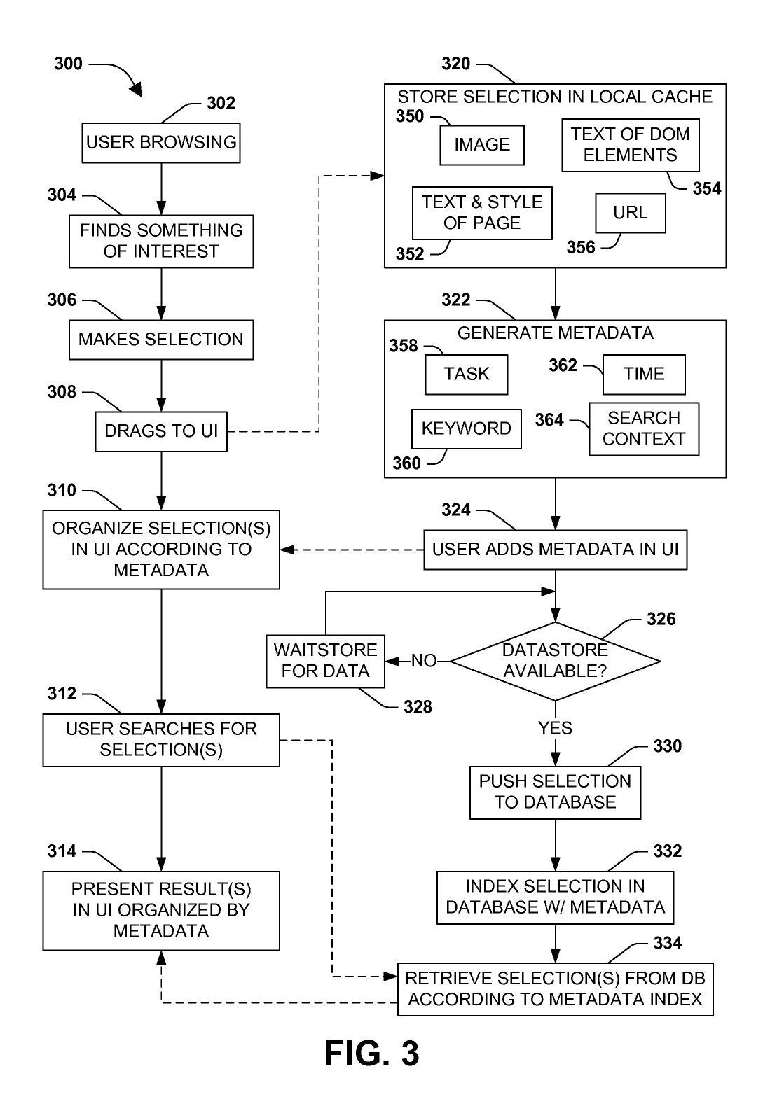

FIG. 3 is a flow diagram illustrating an exemplary embodiment 300 where one or more of portions of a method for saving and retrieving browser-based content or portions thereof for browser-based interactions may be implemented. The exemplary embodiment 300 will, at times, be described below with reference to the exemplary environment of FIG. 2. In the exemplary embodiment 300, at 302, a user may be browsing pages using a browser-based application, for example, visiting various webpages, such as Ron's Bike Shop homepage 204, and/or performing searches for items of interest, such as for “local Bike Shops” 224B.

At 304, the user may find something of interest, and makes a selection of the interesting page or portion of the page, at 306. A selection by the user is not limited to any particular aspect of a browser-related page. For example, the user may select an entire page, such as the webpage for Ron's Bike Shop homepage 204. Further, the user may select merely portions of the page, such as graphics 210 and/or 208, which may be used as a reminder for the user; text blocks 214; and/or a contact section 212. Additionally, the user may combine two or more portions of the page. For example, the user may drag a selection box over a portion of the page to select a plurality of elements of the page, such as underlying document object model (DOM) objects.

In one embodiment, making a selection can comprise dragging the selection of the page or a portion of the page to the UI 202 and dropping the selection on the UI, at 308. For example, in FIG. 2, the user may select the entire webpage “Ron's Bike Shop” homepage 204 (e.g., by clicking on it, or right clicking and selecting) and drag the selection 226 to the UI 202 and drop it in the field 222 comprising or corresponding to a tab 220 associated with particular metadata (e.g., a particular task). In this embodiment, the drag and drop motion can provide for a selection that triggers the generation of metadata, and storage of the selection and metadata, as described above.

In another embodiment, a recording mode can be provided, which can automatically store a plurality of selections, such as pages visited by the user during browsing of one or more pages. For example, when activated (e.g., automatically by default or by the user), the recording mode may select webpages or browser pages visited by the user during a session for a default or assigned time or data storage threshold. This, for example, allows a user to subsequently “playback” the selections, such as by reviewing a list of visited sites, and select one or more pages or portions thereof for further selection and metadata generation.

At 320, the selection can be stored in a local cache. For example, the user's local machine may comprise local memory (e.g., RAM) that is used to temporarily cache data. This local cache can be used to temporarily store the selection, for example, and associated metadata. In one example, the local cache may be memory and file based, where being file based enables the cache to persist between browser sessions, for example, In one embodiment, storing the selection can comprise storing the selection in different manners, or rather storing different portions of the selection differently (e.g., depending upon the type of data being stored and/or different characteristics of the cache). For example, an image 350 of the selection, such as an image of Ron's Bike Shop can be stored separately and/or differently from text and/or text style 352 of the selection, text of underlying document object model (DOM) elements 354 for the selection, such as when a user creates a selection box around a portion of a page, and/or the URL 356 for the selection. It will be appreciated, however, that these are merely some examples of selection related items that can be stored and/or the manners within which such items can be stored, for example, other types of documents that may be stored in the local cache may comprise portable document files (PDFs) and/or word processor documents (e.g., doc or docx files), for example.

At 322, metadata can be automatically generated for the selection. One or more different types of metadata can be automatically generated for the selection. In one embodiment, task-based metadata 358 can be generated for the selection, for example, related to a task that the user may have assigned (e.g., searching for a new bike). In one embodiment, generating the metadata associated with the selection can comprise providing for the user to create personalized metadata for the selection. For example, the user may enter metadata information, such as task related information (e.g., “new bike search”, “important”, “share with team”, etc.).

In one embodiment, the automatically generated metadata may comprise time-related metadata 362. For example, a time of selection can be generated for the selection, and used to organize the selection (e.g., allowing a recent tab in the UI 202 to present selections organized by time, such as the most recent selection at the top of the list). In one embodiment, the automatically generated metadata may comprise keyword-based 360 and/or search context 364 based metadata, such as may be comprised within and/or derived from one or more full text searches. That is, for example, when a user performs a search by entering query keywords (e.g., full text search), the keywords (e.g., text) can be used as metadata associated with the selection. Further, a context for the search, such as a basic idea or concept for the search can be generated and associated with the selection (e.g., query for ailments associated with a headache may be regarded as having a medical context and/or being a medical related query). Additionally, as another example, search related data and/or metadata may be collected from content of a document, such as by text analysis and/or optical character recognition (OCR), and/or object recognition of objects in images, for example.

At 324 in the exemplary embodiment 300 of FIG. 3, the user can add metadata using the UI. For example, the UI 202 comprises tabs 220 for different ways of organizing the selection(s) using the associated metadata. In the example 200, the field 222 of the “task” tab comprises tags or labels “New Bike Search;” “Frogs;” and “Research for Paper on NZ.” In one embodiment, these tags can be entered by the user, such as in a text box in the field 222 of the UI 202. In this way, for example, the user can add personalized metadata to be associated with the selection.

If a remote data store is available, as ascertained at 326, the selection and associated metadata can be pushed to the database, at 330. However, if the remote data store is not available, at 326, the selection and associated metadata remains in local cache until the remote data store is available, at 328. In one embodiment, the remote data store can be comprised in a cloud-based environment, for example, utilizing remote servers to service users by providing the remote data store, and providing client-cloud synchronization for the selection and metadata. A connection to a remote-based data store, such as the cloud environment, may not always be available for a variety of reasons (e.g., local connection down, servers not available, local machine not connected), for example. In this example, the selection and metadata can remain locally until the remote data store becomes available.

At 332, the selection is stored in the database and is indexed by the metadata. For example, the database can comprise the stored information for the selection, such as from 320, and the metadata can be linked to the selection in the database as an index. As another example, the URL, image, and/or text and style for the webpage Ron's Bike Shop homepage 204, for example, can be stored in the database, and metadata for the time of selection, the task (e.g., “new bike search”) and/or keywords for a search the user performed can be linked from an index to the database. In this way, for example, recalling the metadata from the index can recall the selection from the database.

At 310, the selection(s) can be organized in the UI according to associated metadata. For example, when the user selects a browser page, or portion thereof, and moves it to the UI, such as by a drag and drop, the selection can be displayed in the UI according to the associated metadata (e.g., either automatically generated or explicitly generated by the user(s), or both). As an example, a selection from the webpage Ron's Bike Shop can be dragged to the field 222 in the UI 202, and placed under the personalized tag “new bike search.” In this example, the selection can be displayed under the heading Ron's Bike Shop 224A within the field 222 for the task tab.

Further, in one embodiment, an icon can be displayed for the selection that may provide a visual reminder of a type of information that is comprised by the selection. For example, the heading Ron's Bike Shop 224A comprises a globe-type icon which can identify the selection as a webpage 205. Further, the heading “local bike shops” 224B may comprise a search performed the user for bike shops local to their area, where the user selected the search results, or a portion of the results, and moved it to the UI 202, for example. In this example, the icon comprises a globe with a magnifying glass, thereby providing a visual reminder to the user that this selection comprises a web-search. Further, other icons can be used, for example, such as a page over a globe to identify a portion of a webpage. The icon representations are not limited to any particular embodiment, merely that they provide a type of visual reminder to the user about the type of page and how the content was selected, for example.

At 312 in the exemplary embodiment 300 of FIG. 3, a search operation if provided, such as in the UI, may be performed that allows the user to find one or more selections using metadata associated with the respective selections (e.g., which may comprise contextual information, such as time, task, search, and/or full content of the selection information). For example, a search area 218 may be provided that allows the user to enter some search terms (e.g., metadata related keywords). In this example, the user may enter a term “bikes,” which in turn may return the “new bike search” tag or task, providing the associated selections. As described above, the search may use the index comprising the metadata, which is linked to the selections in the database, for example, in order to retrieve selections associated with the indexing metadata, at 334. At 314, the results from the search can be organized in the UI according to the metadata, as described above.

In one embodiment, a plurality of users may be allowed to access the database, to work in collaboration to compile selections and associated metadata. For example, several users may be connected to the database on the remote data store and concurrently or separately add selections and metadata, review selections, search the selections, and perform other available operations. In this way, as an example, research for certain subjects, searches for particular items, or other tasks, etc., may be performed in collaboration, allowing remote users to view and use selections made by a local user. Further, in another embodiment, one or more users may subscribe to one or more feeds, for example, from one or more collaboration databases, for example. As an example, a feed may provide newly added items and/or responses to a standing query that a user registered with a collaboration database to filter on topics, keywords and/or clippings, for example, from one or more specific users that the user may wish to follow, for example.

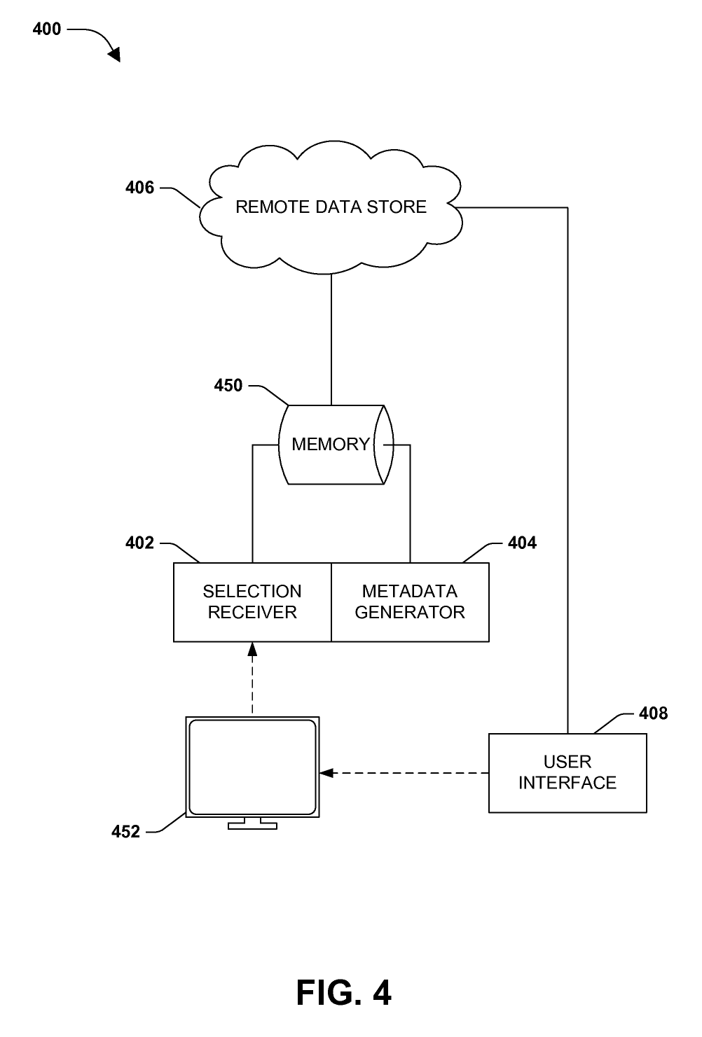

A system may be devised that allows a user to easily manage and retrieve information selected during one or more browser sessions, for example. FIG. 4 is a component diagram of an exemplary system 400 for saving and retrieving browser-based content or portions thereof for browser-based interactions. A selection receiving component 402 receives a user selection, such as from a local machine 452, where the selection comprises at least a portion of content (e.g., of a browser page) selected by a user, and the selection receiving component 402 stores the user selection in memory 450.

A metadata generation component 404 is operably coupled with the selection receiving component 402 (where the metadata generation component 404 can be in the client and/or the cloud), and the metadata generation component 404 generates metadata (in the client and/or the cloud) that is associated with the user selection (e.g., associated with contextual elements, such as time, task and/or search terms, and/or associated with the full content of the selection), and stores the metadata in memory 450. A remote data store component 406 is operably coupled with the memory, such as by an Internet connection, and the remote data store component 406 stores the selection in a database that is indexed by the metadata. A user interface (UI) component 408 is operably coupled with the remote data store, and it is configured to present a multi-level representation of the selection on a local machine 452 utilizing the associated metadata to organize the presentation.

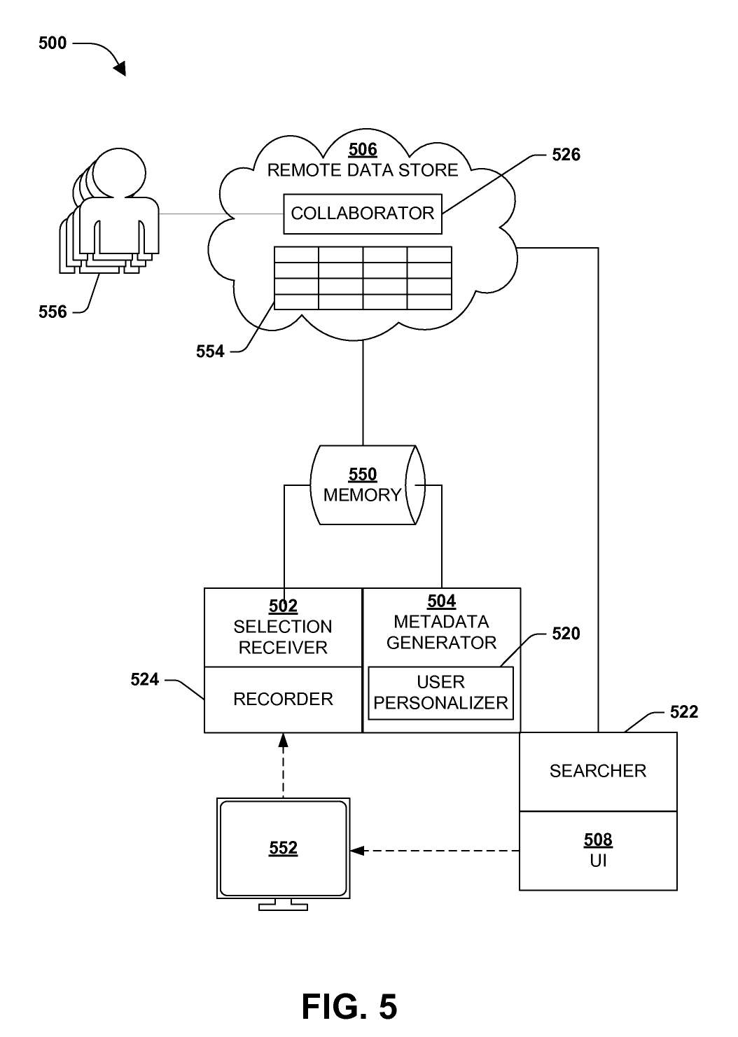

FIG. 5 is a component diagram illustrating one embodiment 500 where one or more systems described herein may be implemented. A search component 522 can provide a search operation allowing a user (e.g., of a local machine 552) to find one or more selections using metadata that indexes a database 554 associated with the respective selections, where the selections were previously made via a selection receiver 502 and the associated metadata was generated by a metadata generation component 504. That is, for example, the user can enter search words into a provided search box in a UI 508, and the searching component 522 can compare the search words against the index of metadata to identify selection(s) in the database 554.

The metadata generation component 504 can comprise a user personalization component 520 that allows a user to generate personalized metadata for the selection, such as by entering tags to particular information. In this embodiment 500 a remote data store 506 can comprise a cloud-based data store that provides client-cloud synchronization for the selection and metadata. That is, for example, the local client machine 552 can connect to cloud-based services, comprising the remote data store, and synchronize data between the cloud and client, such as selections and metadata for the database 554.

A recording component 524 can be configured to automatically cache a plurality of selections (e.g., in memory 550), such as pages visited by the user during browsing of one or more browser pages. The remote data store 506 can comprise a collaboration component 526 that allows a plurality of users 556 to access the database 554 for storing and retrieving the selection (e.g., or plurality of selections) collaboratively. For example, a plurality of users 556 can concurrently or separately connect remotely to the remote data store 506, and the collaboration component can provide access to the same database for adding selections to, or retrieving/reviewing selected information.

Further, in this embodiment 500, the metadata generation component 504 can be configured to automatically generate metadata associated with the selection, where the automatically generated metadata can comprise: tasked-based metadata; time-based metadata; user-tag based metadata; keyword-based metadata; and/or search context based metadata. That is for example, a user can select a page or portion of a page, and the metadata generation component 504 can automatically add metadata that describes the task the user was working on, the time that the selection was created, additional user-created tags, keywords from a search related to the information, and/or contextual information from the search. In this way, in this example, the metadata can provide for flexible search and retrieval of desired information (e.g., selections) by one or more users.

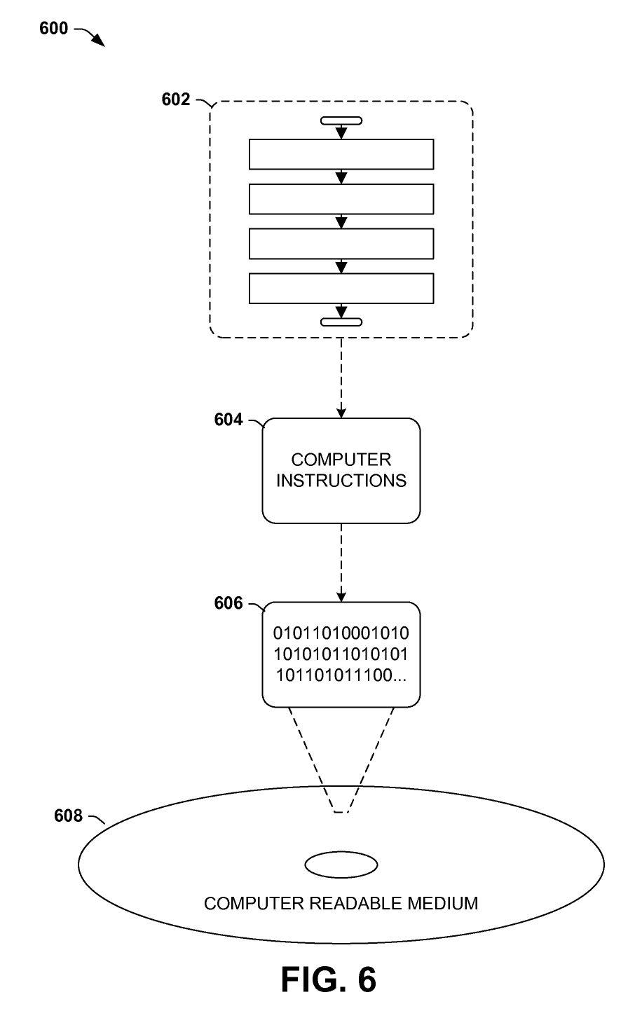

Still another embodiment involves a computer-readable medium comprising processor-executable instructions configured to implement one or more of the techniques presented herein. An exemplary computer-readable medium that may be devised in these ways is illustrated in FIG. 6, wherein the implementation 600 comprises a computer-readable medium 608 (e.g., a CD-R, DVD-R, or a platter of a hard disk drive), on which is encoded computer-readable data 606. This computer-readable data 606 in turn comprises a set of computer instructions 604 configured to operate according to one or more of the principles set forth herein. In one such embodiment 602, the processor-executable instructions 604 may be configured to perform a method, such as the exemplary method 100 of FIG. 1, for example. In another such embodiment, the processor-executable instructions 604 may be configured to implement a system, such as the exemplary system 400 of FIG. 4, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

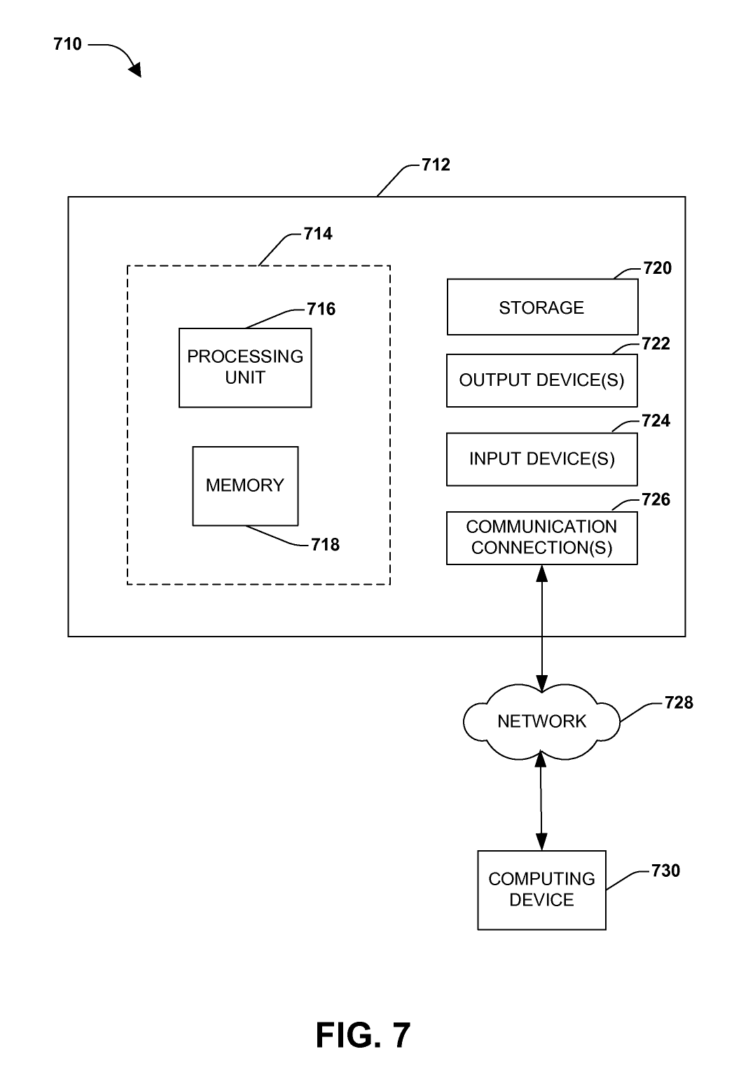

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 710 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for saving and retrieving browser-based content or portions thereof for browser-based interactions, comprising:
upon a user selecting at least a portion of a browser page, generating metadata associated with the selection;
storing the selection in a remote data store comprising a database for the selection indexed by the associated metadata; and
presenting a multi-level representation of the selection in a user interface (UI) using the associated metadata.

2. The method of claim 1, comprising providing a search operation that allows the user to find one or more selections using metadata associated with the respective selections.

3. The method of claim 1, comprising allowing a plurality of users to access the database for storing and retrieving the selection in a collaboration.

4. The method of claim 1, selecting at least a portion of a browser page comprising dragging the selection of the at least a portion of the browser page to the UI and dropping the selection on the UI.

5. The method of claim 1, generating metadata associated with the selection comprising automatically generating metadata associated with the selection, the automatically generated metadata comprising one or more of:
tasked-based metadata;
time-based metadata;
keyword-based metadata; and
context-based metadata.

6. The method of claim 1, generating metadata associated with the selection comprising providing for the user to create personalized metadata for the selection.

7. The method of claim 1, storing the selection comprising storing one or more of:
an image of the selection;
text associated with one or more document object model (DOM) elements that are comprised in the selection;
text and associated style comprised in the selection;
text of the full page;
metadata associated with the selection; and
URL associated with the selection.

8. The method of claim 1, storing the selection in a remote data store comprising storing the selection in a cloud-based data store providing client-cloud synchronization for the selection and metadata.

9. The method of claim 1, presenting a multi-level representation of the selection in the UI comprising presenting a representation of the selection organized by the associated metadata.

10. The method of claim 1, presenting a multi-level representation of the selection in the UI comprising displaying an icon for the selection that provides a visual reminder of a type of information that is comprised by the selection.

11. The method of claim 1, comprising providing a recording mode, which when activated, automatically stores a plurality of selections visited by the user during browsing of one or more pages.

12. The method of claim 1, comprising:
caching one or more most recent selections locally; and
pushing the cached one or more selections to the remote data store when the remote data store is available to receive the selection.

13. A system for saving and retrieving browser-based content or portions thereof for browser-based interactions, comprising:
a selection receiving component configured to receive a user selection comprising at least a portion of a browser page selected by a user and store the user selection in at least one of memory and one or more files;
a metadata generation component operably coupled with the selection receiving component, and configured to generate metadata associated with the user selection and store the metadata in at least one of memory and one or more files;
a remote data store component operably coupled with the at least one of memory and one or more files, and configured to store the selection in a database indexed by the metadata; and
a user interface (UI) component operably coupled with the remote data store, and configured to present a multi-level representation of the selection on a local machine utilizing the associated metadata to organize the presentation.

14. The system of claim 13, comprising a search component configured to providing a search operation that allows the user to find one or more selections using the metadata indexing the database associated with the respective selections.

15. The system of claim 13, the metadata generation component comprising a user personalization component configured to allow a user to generate personalized metadata for the selection.

16. The system of claim 13, the remote data store comprising a cloud-based data store configured to provide client-cloud synchronization for the selection and metadata.

17. The system of claim 13, comprising a recording component configured to automatically cache a plurality of selections visited by the user during browsing of one or more browser pages.

18. The system of claim 13, the remote data store comprising a collaboration component configured to allow a plurality of users to access the database for storing and retrieving the selection collaboratively.

19. The system of claim 13, the metadata generation component configured to automatically generate metadata associated with the selection, the automatically generated metadata comprising one or more of:
tasked-based metadata;
time-based metadata;
keyword-based metadata; and
context-based metadata.

20. A method for saving and retrieving browser-based content or portions thereof for browser-based interactions, comprising:
upon a user selecting at least a portion of a browser page, automatically generating metadata associated with the selection, the automatically generated metadata comprising one or more of:
tasked-based metadata;
time-based metadata;
keyword-based metadata; and
context-based metadata;
providing for the user to create personalized metadata for the selection;
storing the selection in a cloud-based data store providing client-cloud synchronization for the selection and metadata, the cloud-based data store comprising a database for the selection indexed by the metadata associated with the selection, the storing comprising storing one or more of:
an image of the selection;
text associated with one or more document object model (DOM) elements that are comprised in the selection;
text and associated style comprised in the selection; and
URL associated with the selection;
presenting a multi-level representation of the selection in a user interface (UI) organized by the associated metadata; and
providing a search operation that allows the user to find one or more selections using the associated metadata.
